(19) United States
(12) Patent Application Publication
(10) Pub. No.: US 2016/0134845 A1
(43) Pub. Date: May 12, 2016

(54) VISION SUPPORT APPARATUS FOR VEHICLE

(71) Applicant: TOYOTA JIDOSHA KABUSHIKI KAISHA, Toyota-shi (JP)

(72) Inventor: Goro ASAI, Toyota-shi (JP)

(73) Assignee: TOYOTA JIDOSHA KABUSHIKI KAISHA, Toyota-shi (JP)

(21) Appl. No.: 14/874,746

(22) Filed: Oct. 5, 2015

(30) Foreign Application Priority Data
Nov. 11, 2014 (JP) 2014-229135

(51) Int. Cl. H04N 7/18; B60R 1/00; G06T 7/00; H04N 5/235; G06K 9/00

(52) U.S. Cl. CPC H04N 7/185; H04N 5/235; G06K 9/00785; G06T 7/0081; B60R 1/00; G06T 2207/20132; B60R 2300/306; B60R 2300/8066

(57) ABSTRACT

A vision support apparatus for a vehicle is disclosed. The vision support apparatus includes a rear side camera, a rear side image display part that displays a rear side image captured with the rear side camera, an input signal generation part that generates an input signal in response to an operation of a driver, a switch signal generation part that generates a switch signal in response to another operation of the driver, and a switching part that switches a display region adjustment function and an image quality adjustment function in response to the switch signal, the display region adjustment function adjusting a display region of the rear side image in response to the input signal, the image quality adjustment function adjusting an image quality of the rear side image in response to the input signal.

### FIELD

The present invention is related to a vision support apparatus for a vehicle.

### BACKGROUND

A vision support apparatus is known from Japanese Laid-open Patent Publication No. 2014-027353 (referred to as “Patent Document 1” hereinafter) which includes a controller that generates a cropped image by cropping a desired region of a camera image captured by a camera based on an input signal generated by an input operation to an input part.

However, according to a configuration disclosed in Patent Document 1, only the region of the camera image for the cropped image can be adjusted by the input operation to the input part. In the case of displaying the cropped image of the camera image on a display device instead of a door mirror or the like, it is useful to enable adjusting not only the region for the cropped image but also image quality of the cropped image.

Therefore, an object of the present invention is to provide a vision support apparatus that enables adjusting a display region and image quality of an image captured by a camera.

### SUMMARY

According to the present invention, a vision support apparatus for a vehicle is provided, the vision support apparatus including:

a rear side camera that is provided on a side portion of the vehicle and captures a scene in a rear and side direction from the vehicle;

a rear side image display part that displays a rear side image captured with the rear side camera;

an input signal generation part that generates an input signal in response to an operation of a driver;

a switch signal generation part that generates a switch signal in response to another operation of the driver; and

a switching part that switches a display region adjustment function and an image quality adjustment function in response to the switch signal, the display region adjustment function adjusting a display region of the rear side image in response to the input signal, the image quality adjustment function adjusting an image quality of the rear side image in response to the input signal.

### BRIEF DESCRIPTION OF DRAWINGS

FIG. 1 is a diagram illustrating a configuration of an example of a vehicle vision support apparatus 1 according to the present invention.

FIG. 2 is a diagram of a front view illustrating an example of an input apparatus 20.

FIG. 3 is a state (mode) transition diagram illustrating a state transition implemented by a processing device 10.

FIG. 4 is a diagram illustrating a state before a display region adjustment (a previously adjusted state or a default state).

FIG. 5 is a diagram illustrating a state after an adjustment toward an upper side.

FIG. 6 is a diagram illustrating a state after an adjustment toward a left side.

FIG. 7 is a diagram illustrating a state before an image quality adjustment (a previously adjusted state or a default state).

FIG. 8 is a diagram illustrating a display state on a display device 4 during a luminance adjustment.

FIG. 9 is a diagram illustrating a display state on a display device 4 during a contrast adjustment.

FIG. 10 is a diagram illustrating a configuration of an example of a vehicle vision support apparatus 1A according to the present invention.

FIG. 11 is a diagram illustrating an example of an input apparatus 20A.

FIG. 12 is a state (mode) transition diagram illustrating a state transition implemented by a processing device 10A.

### DESCRIPTION OF EMBODIMENTS

In the following, the best mode for carrying out the present invention will be described in detail by referring to the accompanying drawings.

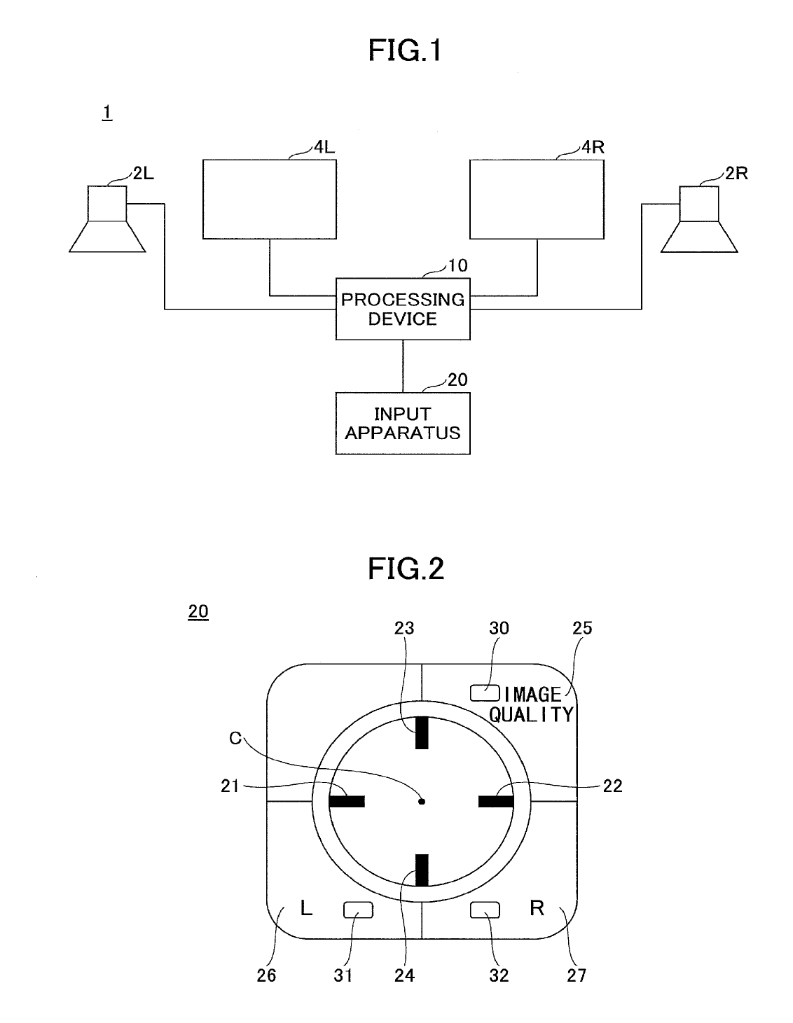

FIG. 1 is a diagram illustrating a configuration of an example (a first embodiment) of a vehicle vision support apparatus 1 according to the present invention. It is noted that connections between elements in FIG. 1 are arbitrary. For example, the connection ways may include a connection via a bus such as a CAN (controller area network), etc., an indirect connection via another ECU, etc., a direct connection, or a connection that enables wireless communication.

The vehicle vision support apparatus 1 is installed on a vehicle that does not include door mirrors (or fender mirrors, the same applies hereinafter) on left and right sides. The vehicle vision support apparatus 1 supports vision of the driver with display apparatuses 4L and 4R, instead of door mirrors. In the following, for the sake of the explanation, the term “door mirror” is used; however, the term “door mirror” means a door mirror that is installed on an ordinary vehicle, and does not mean that the vehicle on which the vehicle vision support apparatus 1 is installed has door mirrors.

The vehicle vision support apparatus 1 includes a camera 2L, a camera 2R, the display apparatus 4L (an example of a rear side image display part), the display apparatus 4R (another example of a rear side image display part), a processing device 10, and an input apparatus 20.

It is noted that, in the following, unless otherwise specified, a left and right direction, a front and rear direction, and an up and down direction are viewed from a passenger (a driver, for example) of the driver of the vehicle on which the vehicle vision support apparatus 1 is installed. It is noted that the left and right direction is not necessarily parallel with a lateral direction of the vehicle, and the up and down direction is not necessarily the same as a vertical direction. Further, the front and rear direction is not necessarily horizontal, and is not necessarily parallel with a front and rear axis of the vehicle.

The camera 2L is provided on a left side portion of the vehicle to capture a scene in the rear direction on the left side from the vehicle. The camera 2L is provided such that the camera 2L captures a region that includes a scene that could be imaged on a left door mirror viewed from the driver seat. The camera 2R is provided on a right side portion of the vehicle to capture a scene in the rear direction on a right side from the vehicle. The camera 2R is provided such that the camera 2R captures a region that includes a scene that could be imaged on a right door mirror viewed from the driver seat. Preferably, the camera 2L and the camera 2R capture color images.

The display apparatus 4L is provided on a left side portion in a cabin of the vehicle such that a screen of the display apparatus 4L can be viewed from the driver seat. The display apparatus 4L is provided near the left door mirror. The display apparatus 4R is provided on a right side portion in a cabin of the vehicle such that a screen of the display apparatus 4R can be viewed from the driver seat. The display apparatus 4R is provided near the right door mirror. The display apparatus 4L and the display apparatus 4R may be implemented by a single display apparatus. In this case, the display apparatus 4L is implemented by a left side region (another example of a rear side image display part) of a screen of the single display apparatus, and the display apparatus 4R is implemented by a right side region (another example of a rear side image display part) of the screen of the single display apparatus.

The display apparatus 4L displays only a first predetermined region (referred to as “cropping region”, hereinafter) of the image captured by the camera 2L. The cropping region is described hereinafter. Similarly, the display apparatus 4R displays only the cropping region of the image captured by the camera 2R. In the following, the image captured by the camera 2L or the camera 2R is also referred to as “a camera image”.

The processing device 10 may be configured with a processor including a CPU. The respective functions of the processing device 10 (including functions described hereinafter) may be implemented by any hardware, any software, any firmware or any combination thereof. The processing device 10 may be implemented by a plurality of processing devices (including processing devices that may be installed in the camera 2L, the camera 2R, the display apparatus 4L and the display apparatus 4R).

The processing device 10 processes input signals generated by the input apparatus 20. The function of the processing device 10 is described hereinafter.

The input apparatus 20 receives input operations from the passenger of the vehicle. The input apparatus 20 is provided in the cabin of the vehicle. The input apparatus 20 is an unified module. In other words, the input apparatus 20 is formed as a single module (unit) and thus is not implemented by a plurality of apparatuses that are physically separated.

FIG. 2 is a diagram of a front view illustrating an example of the input apparatus 20. In the following, it is assumed that the input apparatus 20 is installed in such an orientation that the view of FIG. 2 corresponds to the view from the driver seat. Thus, the up and down direction, and the left and right direction in FIG. 2 correspond to the directions viewed from the passenger. For example, the input apparatus 20 is disposed on a vertical surface of an instrument panel such that the orientation of the input apparatus 20 viewed from the driver seat corresponds to the view of FIG. 2 However, the orientation of the input apparatus 20 is arbitrary. For example, the input apparatus 20 may be disposed at a console box or the like. In this case, “upper side” and “lower side” in the following explanation may be replaced with “far side” and “near side”.

The input apparatus 20 includes a first operation part 21, a second operation part 22, a third operation part 23, a fourth operation part 24 and a fifth operation part 25. In the example illustrated in FIG. 2, the input apparatus 20 further includes a left operation part 26 and a right operation part 27.

The first operation part 21 continues to generate a first input signal during a period in which the first operation part 21 is pressed down. In the example illustrated in FIG. 2, the first operation part 21 is located on the left side with respect to a center C of the input apparatus 20.

The second operation part 22 continues to generate a second input signal during a period in which the second operation part 22 is pressed down. In the example illustrated in FIG. 2, the second operation part 22 is located on the right side with respect to the center C of the input apparatus 20.

The third operation part 23 continues to generate a third input signal during a period in which the third operation part 23 is pressed down. In the example illustrated in FIG. 2, the third operation part 23 is located on the upper side with respect to the center C of the input apparatus 20.

The fourth operation part 24 continues to generate a fourth input signal during a period in which the fourth operation part 24 is pressed down. In the example illustrated in FIG. 2, the fourth operation part 24 is located on the lower side with respect to the center C of the input apparatus 20.

It is noted that, in the example illustrated in FIG. 2, the first operation part 21, the second operation part 22, the third operation part 23 and the fourth operation part 24 are formed as a seesaw switch and thus have a common circle operation member; however, the first operation part 21, the second operation part 22, the third operation part 23 and the fourth operation part 24 may be formed by separate members.

The fifth operation part 25 generates a fifth input signal every time the fifth operation part 25 is pressed down. The fifth operation part 25 is located on the right upper side with respect to the center C of the input apparatus 20. The fifth operation part 25 is provided with letters “image quality” and an indicator 30, as illustrated in FIG. 2. The indicator 30 includes a LED (Light-Emitting Diode), for example. This holds true for another indicator 31, etc.

The left operation part 26 generates a left input signal every time the left operation part 26 is pressed down. The left operation part 26 is located on the left lower side with respect to the center C of the input apparatus 20. The left operation part 26 is provided with a letter “L” that represents “left” and an indicator 31, as illustrated in FIG. 2.

The right operation part 27 generates a right input signal every time the right operation part 27 is pressed down. The right operation part 27 is located on the right lower side with respect to the center C of the input apparatus 20. The right operation part 27 is provided with a letter “R” that represents “right” and an indicator 32, as illustrated in FIG. 2.

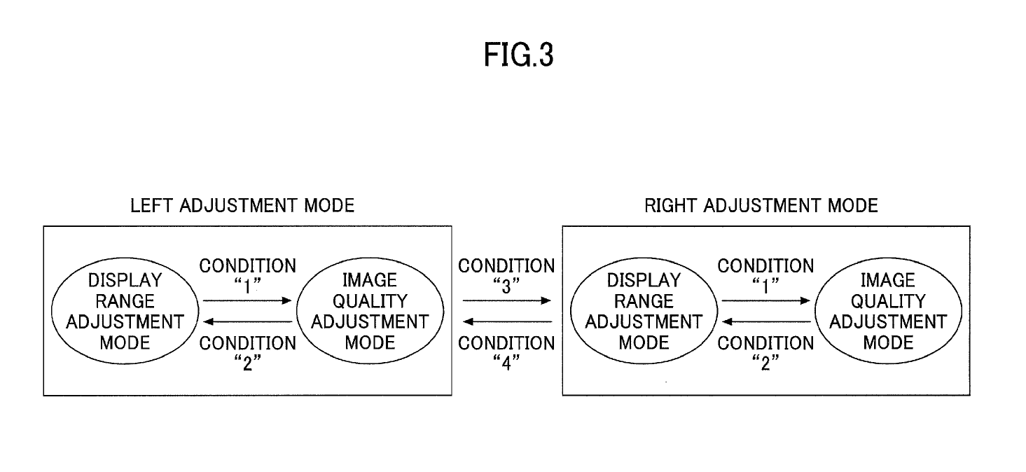

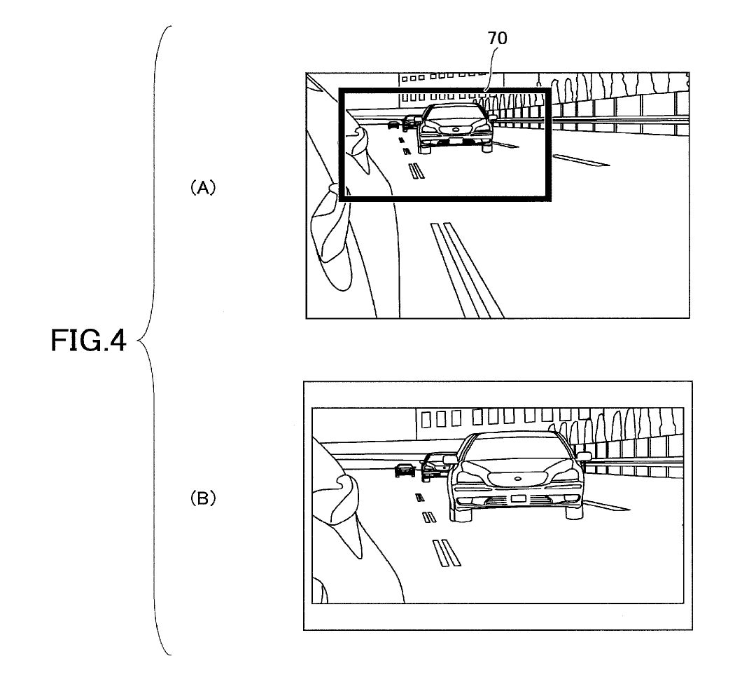

FIG. 3 is a state (mode) transition diagram illustrating a state transition implemented by the processing device 10.

The processing device 10 switches between a left adjustment mode and a right adjustment mode based on the left and right input signals.

The processing device 10 transits to the left adjustment mode when the left input signal is generated during the right adjustment mode (an example of a condition “4”). Further, the processing device 10 transits to the right adjustment mode when the right input signal is generated during the left adjustment mode (an example of a condition “3”).

The left adjustment mode and the right adjustment mode each include an image quality adjustment mode and an display range adjustment mode.

The image quality adjustment mode in the left adjustment mode is related to the camera 2L and the display apparatus 4L. The image quality adjustment mode related to the camera 2L and the display apparatus 4L is provided for adjusting the image quality of the camera image of the camera 2L. Further, the image quality adjustment mode in the right adjustment mode is related to the camera 2R and the display apparatus 4R. The image quality adjustment mode related to the camera 2R and the display apparatus 4R is provided for adjusting the image quality of the camera image of the camera 2R.

The display range adjustment mode in the left adjustment mode is related to the camera 2L and the display apparatus 4L. The display range adjustment mode related to the camera 2L and the display apparatus 4L is provided for adjusting the cropping region of the camera image of the camera 2L. The display range adjustment mode in the left adjustment mode is related to the camera 2R and the display apparatus 4R. The display range adjustment mode related to the camera 2R and the display apparatus 4R is provided for adjusting the cropping region of the camera image of the camera 2R.

The processing device 10 switches between the display range adjustment mode and the image quality adjustment mode based on the fifth input signal from the fifth operation part 25 during the left adjustment mode or the right adjustment mode. For example, the processing device 10 transits to the image quality adjustment mode when the fifth input signal is generated during the display range adjustment mode (an example of a condition “1”). Further, the processing device 10 transits to the display range adjustment mode when the fifth input signal is generated during the image quality adjustment mode (an example of a condition “2”). It is noted that the display range adjustment mode may be initially implemented at the time of turning on power supply of the vehicle. Further, the condition “2” to be met for the transition from the image quality adjustment mode to the display range adjustment mode may include another condition as an OR condition. For example, the condition “2” may be met when non-operation time of the input apparatus 20 becomes greater than or equal to a predetermined time during the image quality adjustment mode.

The processing device 10 turns on the indicator 31 during the left adjustment mode. The processing device 10 turns on the indicator 32 during the right adjustment mode. The processing device 10 turns on the indicator 30 of the fifth operation part 25 during the image quality adjustment mode. Thus, the passenger can easily recognize the current mode based on the states of the indicators 30, 31 and 32. For example, the passenger can recognize the image quality adjustment mode related to the camera 2L and the display apparatus 4L when the indicator 31 is in its ON state and the indicator 30 is in its ON state. Further, the passenger can recognize the image quality adjustment mode related to the camera 2R and the display apparatus 4R when the indicator 32 is in its ON state and the indicator 30 is in its ON state. Further, the passenger can recognize the display range adjustment mode related to the camera 2L and the display apparatus 4L when the indicator 31 is in its ON state and the indicator 30 is in its OFF state. Further, the passenger can recognize the display range adjustment mode related to the camera 2R and the display apparatus 4R when the indicator 32 is in its ON state and the indicator 30 is in its OFF state.

Next, with reference to FIGS. 4 through 6, operations of the processing device 10 in the display range adjustment mode are described. Here, the display range adjustment mode related to the camera 2R and the display apparatus 4R is explained; however, the display range adjustment mode related to the camera 2L and the display apparatus 4L is the same.

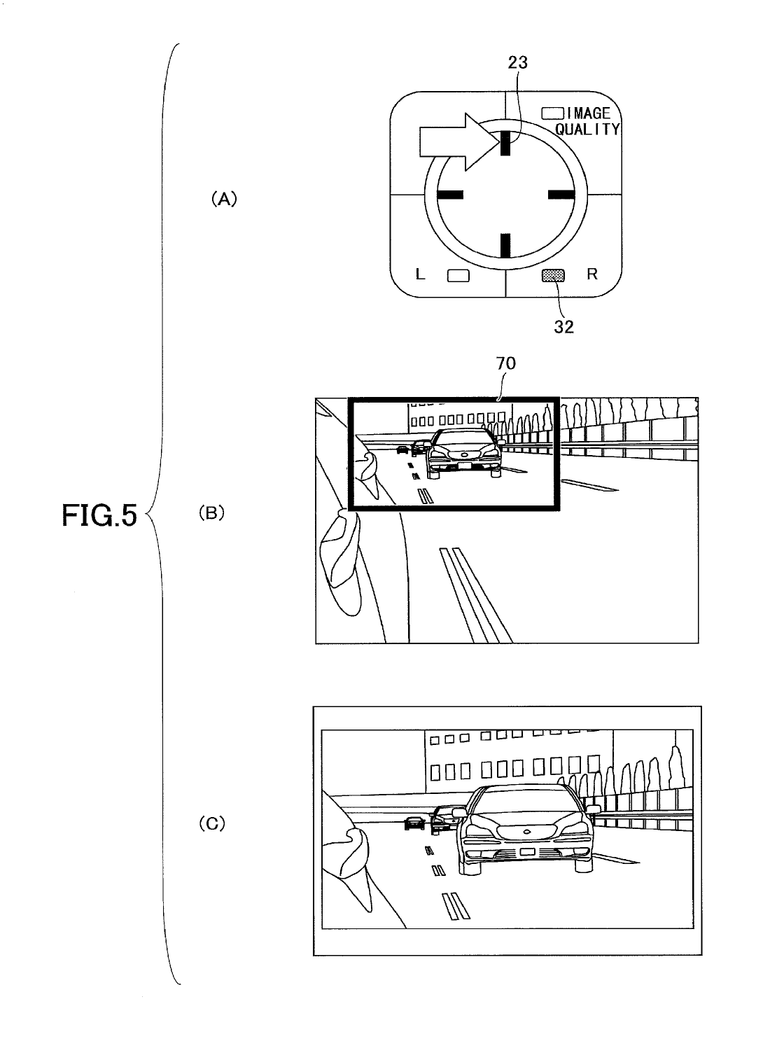

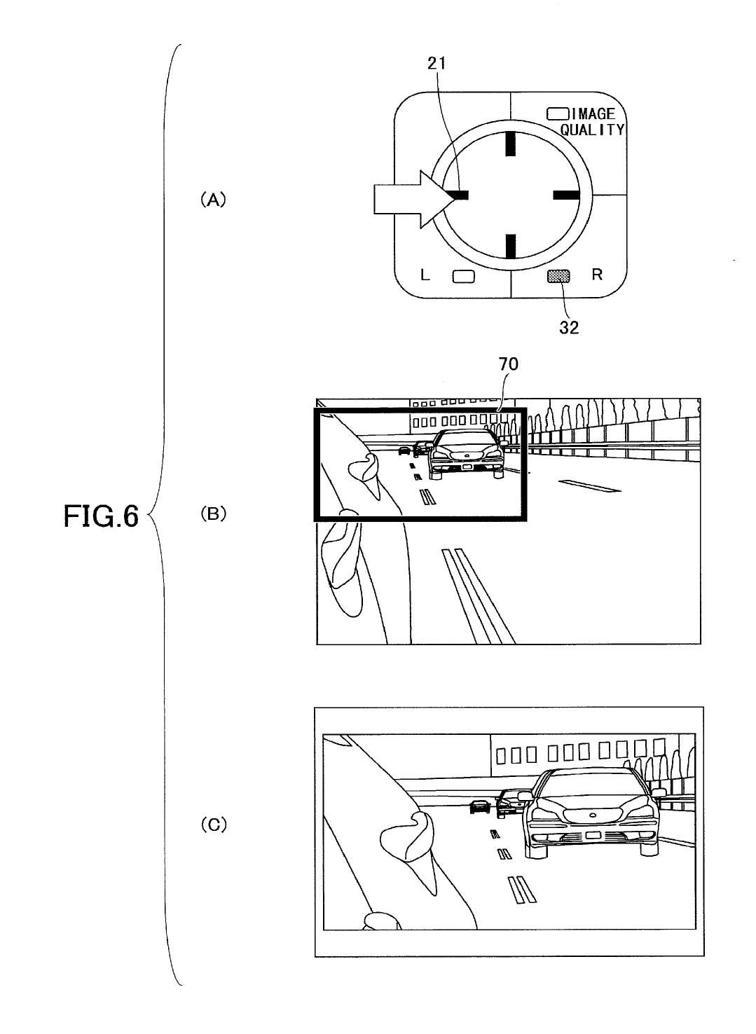

FIG. 4 is a diagram illustrating a state before a display region adjustment (a previously adjusted state or a default state), in which (A) illustrates a relationship between the camera image of the camera 2R and the cropping region, and (B) illustrates a display state on the display apparatus 4R corresponding to the cropping region illustrated in (A). FIG. 5 is a diagram illustrating a state after an adjustment toward the upper side, in which (A) schematically illustrates an arrow of the input operation on the input apparatus 20 at time of the adjustment toward the upper side, (B) illustrates a relationship between the camera image of the camera 2R and the cropping region after the adjustment, and (C) illustrates the display state on the display apparatus 4R corresponding to the cropping region illustrated in (B). FIG. 6 is a diagram illustrating a state after an adjustment toward the left side, in which (A) schematically illustrates an arrow of the input operation on the input apparatus 20 at time of the adjustment toward the left side, (B) illustrates a relationship between the camera image of the camera 2R and the cropping region after the adjustment, and (C) illustrates the display state on the display apparatus 4R corresponding to the cropping region illustrated in (B). It is noted that in FIG. 4 through FIG. 6, the cropping regions are indicated by a rectangular frame 70.

The processing device 10 moves the cropping region in the left direction at a predetermined first movement speed V1 per unit time during the period in which the first input signal is generated, as illustrated in FIGS. 6 (A) and (B), once the first input signal is generated by the operation on the first operation part 21. However, the processing device 10 stops the movement of the cropping region in the left direction when the cropping region reaches a left limit position of the camera image. The left limit position is such that the left side of the cropping region corresponds to a left edge of the camera image, as illustrated in FIG. 6 (B), for example. Thus, the processing device 10 moves the cropping region in the left direction at the predetermined first movement speed V1 per unit time until the cropping region reaches the left limit position of the camera image, during the period in which the first input signal is generated. Accordingly, as illustrated in FIG. 6 (C), the display state on the display apparatus 4R is changed. Specifically, the image portion within the cropping region after the adjustment is displayed on the display apparatus 4R. It is noted that the movement of the cropping region and change in the display on the display apparatus 4R are related to each other (synchronized) in real time. The predetermined first movement speed V1 may be fixed or varied during the period in which the first input signal is generated.

The processing device 10 moves the cropping region in the right direction at the predetermined first movement speed V1 per unit time during the period in which the second input signal is generated, once the second input signal is generated by the operation on the second operation part 22 (not illustrated). However, the processing device 10 stops the movement of the cropping region in the right direction when the cropping region reaches a right limit position of the camera image. The movement of the cropping region in the right direction causes the display state on the display apparatus 4R to be changed correspondingly.

The processing device 10 moves the cropping region in the upper direction at a predetermined second movement speed V2 per unit time during the period in which the third input signal is generated, as illustrated in FIGS. 5 (A) and (B), once the third input signal is generated by the operation on the third operation part 23. However, the processing device 10 stops the movement of the cropping region in the upper direction when the cropping region reaches an upper limit position of the camera image. The upper limit position is such that the upper side of the cropping region corresponds to an upper edge of the camera image, as illustrated in FIG. 5 (B), for example. Thus, the processing device 10 moves the cropping region in the upper direction at the predetermined second movement speed V2 per unit time until the cropping region reaches the upper limit position of the camera image, during the period in which the third input signal is generated. It is noted that, in general, the second movement speed V2 is the same as the first movement speed V1; however, the second movement speed V2 may be different from the first movement speed V1. Further, the second movement speed V2 may be fixed or varied, as is the case with the first movement speed V1.

The processing device 10 moves the cropping region in the lower direction at the predetermined second movement speed V2 per unit time during the period in which the fourth input signal is generated, once the fourth input signal is generated by the operation on the fourth operation part 24 (not illustrated). However, the processing device 10 stops the movement of the cropping region in the lower direction when the cropping region reaches a lower limit position of the camera image. The movement of the cropping region in the lower direction causes the display state on the display apparatus 4R to be changed correspondingly.

According to the example illustrated in FIGS. 4 through 6, the passenger can adjust the cropping region of the camera image in the upper, lower, left and right directions to a desired position by operating the first operation part 21, the second operation part 22, the third operation part 23 and the fourth operation part 24 of the input apparatus 20.

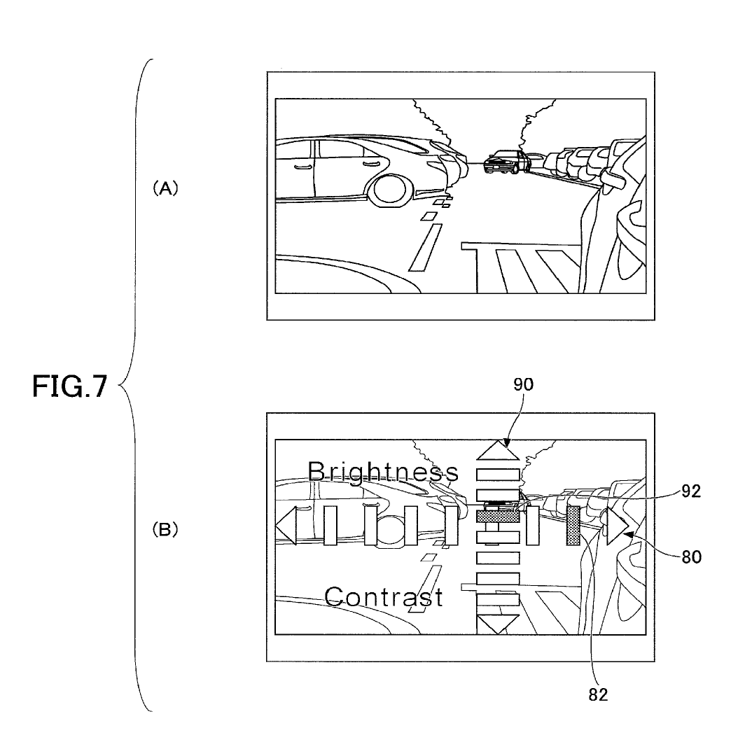

Next, with reference to FIGS. 7 through 9, operations of the processing device 10 in the image quality adjustment mode are described. Here, the image quality adjustment mode related to the camera 2L and the display apparatus 4L is explained; however, the image quality adjustment mode related to the camera 2R and the display apparatus 4R is the same.

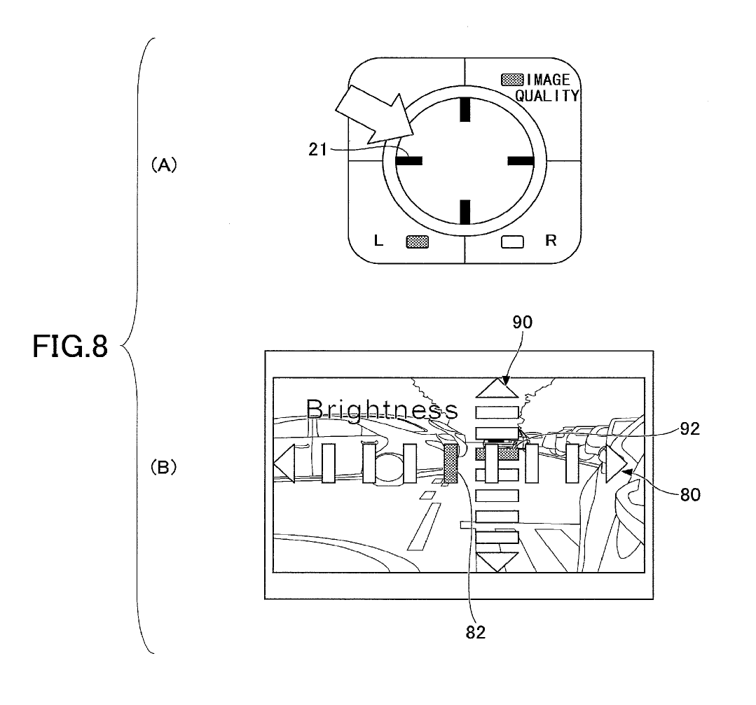

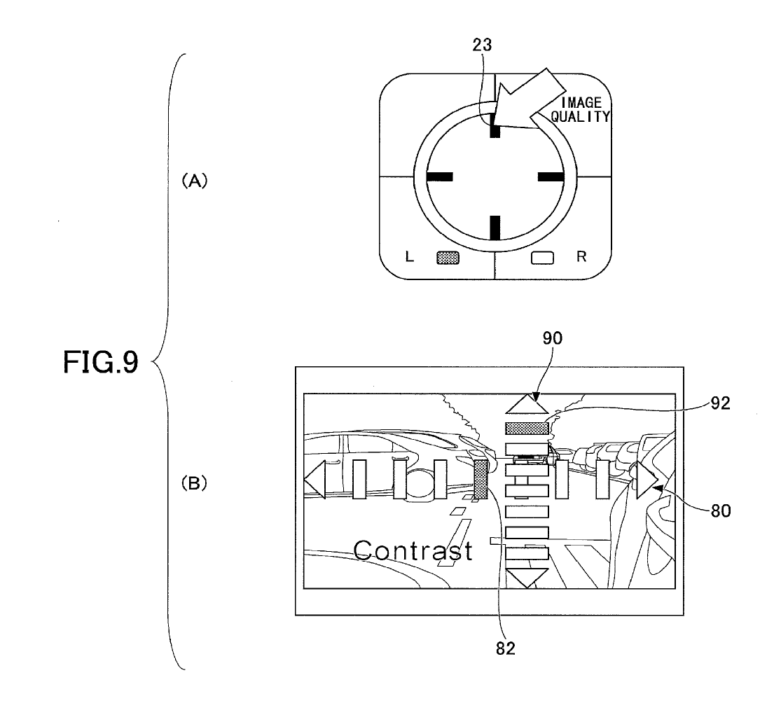

FIG. 7 is a diagram illustrating a state before an image quality adjustment (a previously adjusted state or a default state), in which (A) illustrates the display state on the display apparatus 4L before the transition to the image quality adjustment mode, and (B) illustrates the display state on the display apparatus 4L immediately after the transition to the image quality adjustment mode. FIG. 8 is a diagram illustrating the display state on the display device 4 during a luminance adjustment, in which (A) schematically illustrates, with an arrow, the input operation on the input apparatus 20 during the luminance adjustment, and (B) illustrates the display state on the display apparatus 4L during the luminance adjustment. FIG. 9 is a diagram illustrating the display state on the display device during a contrast adjustment, in which (A) schematically illustrates, with an arrow, the input operation on the input apparatus 20 during the contrast adjustment, and (B) illustrates the display state on the display apparatus 4L during the contrast adjustment.

At the time of the transition to the image quality adjustment mode, the processing device 10 outputs (superimposes) a luminance meter image 80 and a contrast meter image 90 on the display state illustrated in FIG. 7 (A), as illustrated in FIG. 7 (B).

The luminance meter image 80 includes meters (scale meters) extending in a horizontal direction of the image. The number of the meters of the luminance meter image 80 is arbitrary. The luminance meter image 80 includes a current luminance image 82 that indicates the current luminance adjustment position (setting position). The current luminance image 82 may be implemented by featuring (with a color, for example) the corresponding meter of the luminance meter image 80 with respect to other meters. The luminance meter image 80 is configured such that the left position of the current luminance image 82 means higher luminance; however, it may be reversed in another embodiment. The luminance meter image 80 further includes a word that represents a meaning of the luminance meter image 80, such as “Brightness”, as illustrated in FIG. 7 (B).

The contrast meter image 90 includes meters extending in a vertical direction of the image. The number of the meters of the contrast meter image 90 is arbitrary. The contrast meter image 90 includes a current contrast image 92 that indicates the current contrast adjustment position (setting position). The current contrast image 92 may be implemented by featuring (with a color, for example) the corresponding meter of the contrast meter image 90 with respect to other meters. The contrast meter image 90 is configured such that the upper position of the current contrast image 92 means higher contrast; however, it may be reversed in another embodiment. The contrast meter image 90 further includes a word that represents a meaning of the contrast meter image 90, such as “Contrast”, as illustrated in FIG. 7 (B).

The processing device 10 changes the luminance in the cropping region of the camera image in a first direction (a direction in which the luminance becomes higher, in this example) at a predetermined first change speed V11 per unit time during the period in which the first input signal is generated, once the first input signal is generated by the operation on the first operation part 21, as illustrated in FIG. 8 (A). It is noted that the processing device 10 may change the luminance in the cropping region by changing the luminance in the camera image as a whole or only the luminance in the cropping region. The processing device 10 stops the change in the luminance in the cropping region in the first direction when the luminance in the cropping region reaches a predetermined first limit value (an upper luminance limit, in this example) while the first input signal is being generated. Thus, the processing device 10 changes the luminance in the cropping region in the first direction at the predetermined first change speed V11 per unit time until the luminance in the cropping region reaches the predetermined first limit value, during the period in which the first input signal is generated. This causes the display state on the display apparatus 4L (i.e., the luminance of the displayed image) to be changed correspondingly. Specifically, the image portion within the cropping region after the luminance adjustment is displayed on the display apparatus 4L. It is noted that the change in the luminance in the cropping region and change in the display on the display apparatus 4L are related to each other (synchronized) in real time. The first change speed V11 may be fixed or varied during the period in which the first input signal is generated. Further, the processing device 10 moves the position of the current luminance image 82 in the left direction in synchronization with the increase in the luminance in the cropping region, as illustrated in FIG. 8 (B). It is noted that, as illustrated in contrast between FIG. 8 and FIG. 9, the luminance meter image 80 may be superimposed on the contrast meter image 90 during the luminance adjustment. Further, during the luminance adjustment, the word “Contrast” may not be displayed.

The processing device 10 changes the luminance in the cropping region in a second direction (a direction in which the luminance becomes lower, in this example) at the predetermined first change speed V11 per unit time during the period in which the second input signal is generated, once the second input signal is generated by the operation on the second operation part 22 (not illustrated). However, the processing device 10 stops the change in the luminance in the cropping region in the second direction when the luminance in the cropping region reaches a predetermined second limit value (a lower luminance limit, in this example) while the second input signal is being generated. The change in the luminance in the cropping region in the second direction causes the display state on the display apparatus 4L to be changed correspondingly. Further, the processing device 10 moves the position of the current luminance image 82 in the right direction in synchronization with the decrease in the luminance in the cropping region.

It is noted that, in another embodiment, the processing device 10 may move the contrast meter image 90 as a whole in the left or right direction according to the movement of the current luminance image 82 in the left and right direction such that the lateral position of the contrast meter image 90 corresponds to the position of the current luminance image 82.

The processing device 10 changes the contrast in the cropping region of the camera image in a third direction (a direction in which the contrast becomes higher, in this example) at a predetermined second change speed V12 per unit time during the period in which the third input signal is generated, once the third input signal is generated by the operation on the third operation part 23, as illustrated in FIG. 9 (A). It is noted that the processing device 10 may change the contrast in the cropping region by changing the contrast in the camera image as a whole or only the contrast in the cropping region. The processing device 10 stops the change in the contrast in the cropping region in the third direction when the contrast in the cropping region reaches a predetermined third limit value (an upper contrast limit, in this example) while the third input signal is being generated. Thus, the processing device 10 changes the contrast in the cropping region in the third direction at the predetermined second change speed V12 per unit time until the contrast in the cropping region reaches the predetermined third limit value, during the period in which the third input signal is generated. This causes the display state on the display apparatus 4L (i.e., the contrast of the displayed image) to be changed correspondingly. Specifically, the image portion within the cropping region after the contrast adjustment is displayed on the display apparatus 4L. It is noted that the change in the contrast in the cropping region and change in the display on the display apparatus 4L are related to each other (synchronized) in real time. It is noted that, in general, the second change speed V12 is the same as the first change speed V11; however, the second change speed V12 may be different from the first change speed V11. The second change speed V12 may be fixed or varied during the period in which the third input signal is generated. Further, the processing device 10 moves the position of the current contrast image 92 in the upper direction in synchronization with the increase in the contrast in the cropping region, as illustrated in FIG. 9 (B). It is noted that, as illustrated in contrast between FIG. 9 and FIG. 8, the contrast meter image 90 may be superimposed on the luminance meter image 80 during the contrast adjustment. Further, during the contrast adjustment, the word “Brightness” may not be displayed.

The processing device 10 changes the contrast in the cropping region in a fourth direction (a direction in which the contrast becomes lower, in this example) at the predetermined second change speed V12 per unit time during the period in which the fourth input signal is generated, once the fourth input signal is generated by the operation on the fourth operation part 24 (not illustrated). However, the processing device 10 stops the change in the contrast in the cropping region in the fourth direction when the contrast in the cropping region reaches a predetermined fourth limit value (a lower contrast limit, in this example) while the fourth input signal is being generated. The change in the contrast in the cropping region in the fourth direction causes the display state on the display apparatus 4L to be changed correspondingly. Further, the processing device 10 moves the position of the current contrast image 92 in the lower direction in synchronization with the decrease in the contrast in the cropping region.

It is noted that, in another embodiment, the processing device 10 may move the luminance meter image 80 as a whole in the upper or lower direction according to the movement of the current contrast image 92 in the upper and lower direction such that the vertical position of the luminance meter image 80 corresponds to the position of the current contrast image 92.

According to the example illustrated in FIGS. 7 through 9, the passenger can adjust the luminance and the contrast in the cropping region of the camera image to desired values by operating the first operation part 21, the second operation part 22, the third operation part 23 and the fourth operation part 24 of the input apparatus 20.

It is noted that, in the examples illustrated in FIGS. 7 through 9, the luminance is indicated by the luminance meter image 80 in the horizontal direction and the contrast is indicated by the contrast meter image 90 in the vertical direction; however, this may be reversed. Specifically, the contrast may be indicated by a horizontal meter display, and the luminance may be indicated by a vertical meter display. In this case, the processing device 10 adjusts the contrast and moves the current image quality position in the horizontal meter image in the left or right direction according to the first input signal and the second input signal in the image quality adjustment mode. Further, the processing device 10 adjusts the luminance and moves the current image quality position in the vertical meter image in the upper or lower direction according to the third input signal and the fourth input signal in the image quality adjustment mode.

Further, in the examples illustrated in FIGS. 7 through 9, the adjustment of the image quality is related to the luminance and the contrast; however, other type of the image qualities (a hue, a sharpness, for example) may be adjusted instead.

Further, in the examples illustrated in FIGS. 7 through 9, the movements of the current luminance image 82 and the current contrast image 92 are implemented by changing the positions of the featured portions (meter portions with a different color, for example) of the luminance meter image 80 and the contrast meter image 90; however, other ways may be used. For example, the current luminance image 82 and the current contrast image 92 may be marks that differ from the luminance meter image 80 and the contrast meter image 90, and the marks may be moved.

According to the first embodiment, the passenger can adjust not only the cropping region of the camera image to the desired position in the upper, lower, left and right directions but also the luminance and the contrast in the cropping region of the camera image to the desired values by operating the first, second, third and fourth operation parts 21 through 24 of the input apparatus 20. Thus, it becomes possible to increase functions of the input apparatus 20 without increasing a size of the input apparatus 20.

Further, according to the first embodiment, different processes are performed in response to the input signal of the same type between the display range adjustment mode and the image quality adjustment mode, while the movement direction of the cropping region and the movement directions of the current luminance image 82 and the current contrast image 92 in response to the input signal of the same type are the same. Thus, the passenger can adjust, with the same feeling, the image quality and the cropping region. For example, the movement direction of the cropping region and the movement direction of the current luminance image 82 in response to the first input signal are the same (i.e., the left direction), which enables the passenger to perform the adjustment of the luminance with the same feeling as the adjustment of the cropping region. Further, the movement direction of the cropping region and the movement direction of the current contrast image 92 in response to the third input signal are the same (i.e., the upper direction), which enables the passenger to perform the adjustment of the contrast with the same feeling as the adjustment of the cropping region.

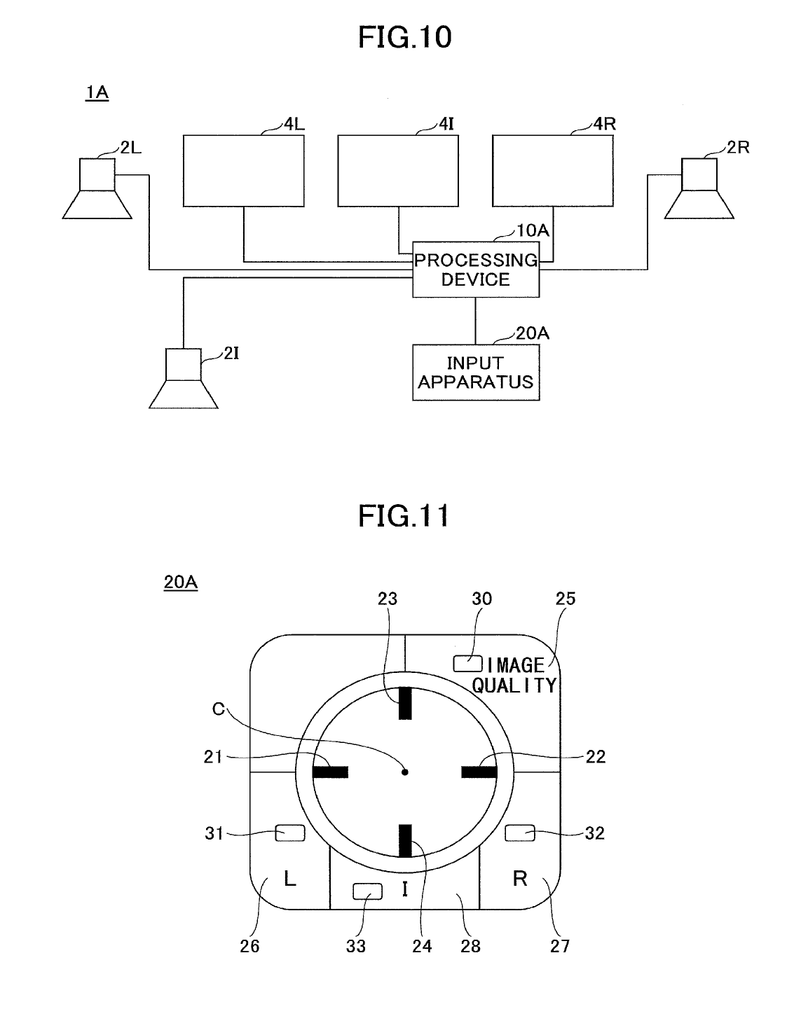

FIG. 10 is a diagram illustrating a configuration of an example (a second embodiment) of a vehicle vision support apparatus 1A according to the present invention.

The vehicle vision support apparatus 1A illustrated in FIG. 10 differs from the vehicle vision support apparatus 1 illustrated in FIG. 1 in that a camera 2I and a display apparatus 4I (an example of a rear image display part) are added, the processing device 10 is replaced with a processing device 10A, and the input apparatus 20 is replaced with an input apparatus 20A. Other components may be substantially the same, and further explanation thereof is omitted by using the reference numerals in FIG. 1.

The vehicle vision support apparatus 1A is installed on a vehicle that does not include the left and right mirrors and an inner mirror (i.e., a room mirror). The vehicle vision support apparatus 1A supports the vision of the driver with the display apparatuses 4L, 4R and 4I, instead of door mirrors and the inner mirror. In the following, for the sake of the explanation, the term “inner mirror” is used; however, the term “inner mirror” means an inner mirror that is installed on an ordinary vehicle, and does not mean that the vehicle on which the vehicle vision support apparatus 1A is installed has an inner mirror.

The camera 2I is provided on a rear side portion of the vehicle to capture a scene in the rear direction from the vehicle. The camera 2I is provided such that the camera 2I captures a region that includes a scene that could be imaged on an inner mirror viewed from the driver seat.

The display apparatus 4I is provided, instead of the inner mirror, at the position of the inner mirror (near an upper end of a front wind shield). The display apparatus 4I displays only a second predetermined region (i.e., the cropping region) of the image captured by the camera 2I. It is noted that a size of the second predetermined region is determined according to a screen size of the display apparatus 4I. It is noted that the display apparatus 4I may be implemented by a single display apparatus together with the display apparatuses 4L and 4R. In this case, the display apparatus 4L is implemented by a left side region of a screen of the single display apparatus, the display apparatus 4R is implemented by a right side region of the screen of the single display apparatus, and the display apparatus 4I is implemented by a center region of the screen of the single display apparatus (another example of a rear image display part).

The processing device 10A processes input signals generated by the input apparatus 20A. The function of the processing device 10A is described hereinafter.

FIG. 11 is a diagram of a front view illustrating an example of the input apparatus 20A.

The input apparatus 20A illustrated in FIG. 11 differs from the input apparatus 20 illustrated in FIG. 2, etc., in that a seventh operation part 28 is provided between the left operation part 26 and the right operation part 27 in the left and right direction. Other components may be substantially the same, and further explanation thereof is omitted by using the reference numerals in FIG. 2.

The seventh operation part 28 generates a seventh input signal every time the seventh operation part 28 is pressed down. The seventh operation part 28 is located directly below the center C of the input apparatus 20. The seventh operation part 28 is provided with a letter “I” that represents “inner mirror” and an indicator 33, as illustrated in FIG. 11.

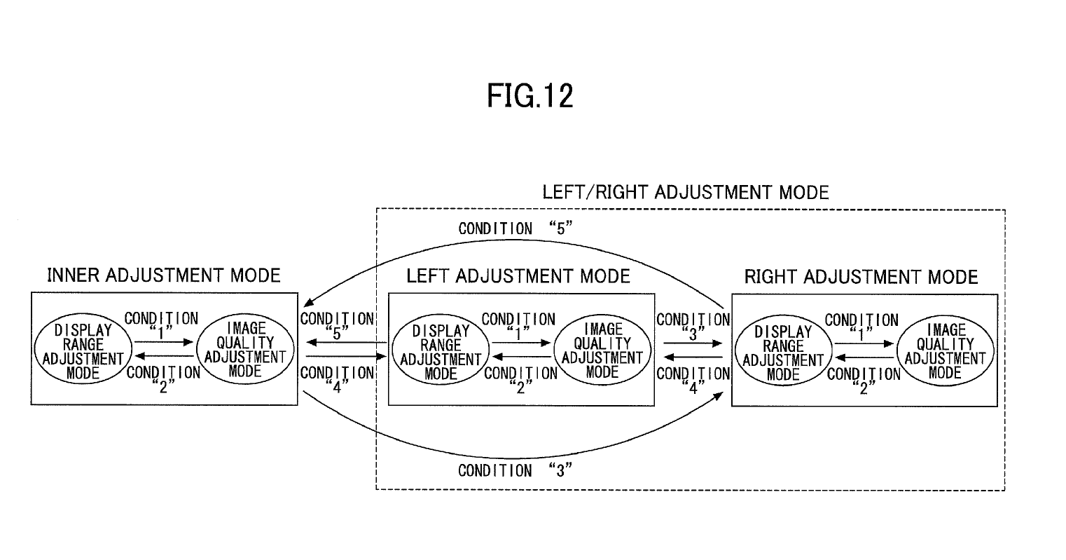

FIG. 12 is a state (mode) transition diagram illustrating a state transition implemented by the processing device 10A. An explanation of conditions that may be the same as illustrated in FIG. 3 is omitted.

In the example illustrated in FIG. 12, an operation mode of the processing device 10A includes a left/right adjustment mode and an inner adjustment mode. The left/right adjustment mode includes the left adjustment mode and the right adjustment mode illustrated in FIG. 2. The inner adjustment mode includes a display range adjustment mode for adjusting a cropping region of the camera image of the camera 2I, and an image quality adjustment mode for adjusting an image quality of the camera image of the camera 2I, as is the case with the left adjustment mode and the right adjustment mode.

The processing device 10A switches between the left adjustment mode, the right adjustment mode, and the inner adjustment mode based on the left input signal generated by the left operation part 26, the right input signal generated by the right operation part 27, and the seventh operation part 28. For example, the processing device 10A transits to the inner adjustment mode when the seventh input signal is generated during the left adjustment mode or the right adjustment mode (an example of a condition “5”). Further, the processing device 10A transits to the left adjustment mode when the left input signal is generated during the inner adjustment mode (an example of a condition “4”). Further, the processing device 10A transits to the right adjustment mode when the right input signal is generated during the inner adjustment mode (an example of a condition “3”). The operations in the left/right adjustment mode (the left adjustment mode and the right adjustment mode) may be the same as those implemented by the processing device 10 described above. The processing device 10A turns on the indicator 33 during the inner adjustment mode.

The operations in the display range adjustment mode related to the inner adjustment mode and the image quality adjustment mode related to the inner adjustment mode may be the same as those in the display range adjustment mode and the image quality adjustment mode, respectively, implemented by the processing device 10 described above. The explanation related to the display range adjustment mode for the camera 2R and the display apparatus 4R is equally applied to the display range adjustment mode for the camera 2I and the display apparatus 4I. Further, the explanation related to the image quality adjustment mode for the camera 2R and the display apparatus 4R is equally applied to the image quality adjustment mode for the camera 2I and the display apparatus 4I.

According to the second embodiment, the following effects can be obtained in addition to the effects obtained in the first embodiment described above. According to the second embodiment, the passenger can adjust not only the cropping region of the camera image of the camera 2I to the desired position in the upper, lower, left and right directions but also the luminance and the contrast in the cropping region of the camera image of the camera 2I to the desired values by operating the first, second, third and fourth operation parts 21 through 24 of the input apparatus 20. Thus, it becomes possible to increase functions of the input apparatus 20 without increasing a size of the input apparatus 20.

It is noted that, according to the second embodiment, a configuration with which the inner mirror may be replaced is added; however, in addition to or instead of such a configuration, another configuration with which another mirror (a side under mirror, for example) may be replaced may be added.

The present invention is disclosed with reference to the preferred embodiments. However, it should be understood that the present invention is not limited to the above-described embodiments, and variations and modifications may be made without departing from the scope of the present invention.

For example, according to the embodiment, the fifth operation part 25 is a single operation part; however, the fifth operation part 25 may include two operation parts. In this case, when one of these two operation parts of the fifth operation part 25 is operated (another example of the condition “2” in FIG. 3, etc.), the display range adjustment mode may be implemented, and when the other is operated (another example of the condition “1” in FIG. 3, etc.), the image quality adjustment mode may be implemented.

Further, in the embodiments described above, the fifth operation part 25 may be disposed at a location that is separated from other operation parts (the first operation part 21, for example). Further, the fifth operation part 25 may be the same as other operation parts (the first operation part 21, for example). For example, the fifth operation part 25 may be validated when another operation part is pressed down and held for a predetermined time. In other words, the fifth input signal may be generated when another operation part is pressed down and held for a predetermined time.

Further, according to the embodiments described above, the input apparatus 20 (the same holds true for the input apparatus 20A) enables four directional operations in orthogonal directions with the first, second, third and fourth operation parts 21 through 24; however, more than four directional operations, such as eight directional operations, may be enabled. For example, in the case of the eight directional operations, the movement of the cropping region of the camera image in a slanting direction may be enabled in the display range adjustment mode. Further, in the case of the eight directional operations, the luminance and the contrast may be adjusted simultaneously, or adjustments of other types of the image qualities (a hue, a sharpness, for example) may be enabled.

The present application is based on and claims the benefit of priority of Japanese Priority Application No. 2014-229135, filed on Nov. 11, 2014, the entire contents of which are hereby incorporated by reference.

What is claimed is:

1. A vision support apparatus for a vehicle, the vision support apparatus comprising:
a rear side camera that is provided on a side portion of the vehicle and captures a scene in a rear and side direction from the vehicle;
a rear side image display part that displays a rear side image captured with the rear side camera;
an input signal generation part that generates an input signal in response to an operation of a driver;
a switch signal generation part that generates a switch signal in response to another operation of the driver; and
a switching part that switches a display region adjustment function and an image quality adjustment function in response to the switch signal, the display region adjustment function adjusting a display region of the rear side image in response to the input signal, the image quality adjustment function adjusting an image quality of the rear side image in response to the input signal.

2. The vision support apparatus of claim 1, wherein the input signal generation part and the switch signal generation part are provided in an input device that is formed as a single module.

3. The vision support apparatus of claim 1, wherein the image quality is a luminance or a contrast.

4. The vision support apparatus of claim 1, further comprising:
a rear camera that is provided on a rear portion of the vehicle and captures another scene in a rear direction from the vehicle;
a selection operation part that generates a selection signal; and
a rear image display part that displays a rear image captured by the rear camera, wherein
the switching part switches between an adjustment function of the rear side camera and an adjustment function of the rear camera in response to the selection signal,
in a state in which the adjustment function of the rear side camera is selected,
the switching part adjusts the display region of the rear side image or the image quality of the rear side image in response to the input signal, and
in a state in which the adjustment function of the rear camera is selected,
the switching part adjusts the display region of the rear image or the image quality of the rear image in response to the input signal.
